(19) United States
(12) Patent Application Publication
(10) Pub. No.: US 2009/0324815 A1
(43) Pub. Date: Dec. 31, 2009

(54) MARKING APPARATUS AND MARKING METHODS USING MARKING DISPENSER WITH MACHINE-READABLE ID MECHANISM

(76) Inventors: Steven E. Nielsen, North Palm Beach, FL (US); Curtis Chambers, Palm Beach Gardens, FL (US); Jeffrey Farr, Jupiter, FL (US)

Correspondence Address: WOLF GREENFIELD & SACKS, P.C., 600 ATLANTIC AVENUE, BOSTON, MA, 02210-2206, US

(21) Appl. No.: 12/429,929

(22) Filed: Apr. 24, 2009

Related U.S. Application Data
(60) Provisional application No. 61/075,882, filed on Jun. 26, 2008.

(51) Int. Cl. E01C 23/22; B05C 17/00; B65D 83/16

(52) U.S. Cl. 427/137; 118/713

(57) ABSTRACT

Marking devices for dispensing markers on the ground and marking methods are provided. The marking devices and marking methods use a marking dispenser having a machine-readable ID mechanism. The ID mechanism has data storage capability. In one embodiment, the marking dispenser may be provided with a radio-frequency identification (RFID) tag. In another embodiment, the marking dispenser may be provided with a barcode. The type of information that may be encoded in the ID mechanism may include, but is not limited to, product-specific information, user-specific information, other predetermined information of interest, and any combination thereof. The ID information encoded in the ID mechanism may be collected and used for various purposes, such as, but not limited to, real-time product verification, tracking which user location received a batch of marking paint, tracking marking paint inventory, tracking marking paint problems, and tracking marking paint usage.

### CROSS REFERENCE TO RELATED APPLICATION

This application claims priority based on Provisional Application Ser. No. 61/075,882, filed Jun. 26, 2008, which is hereby incorporated by reference in its entirety.

### FIELD OF THE INVENTION

The present invention relates generally to the field of marking devices for placing marks on the ground. In particular, the present invention relates to marking devices and marking methods using marking dispensers each having a machine-readable ID mechanism affixed thereto.

### BACKGROUND

Marking paint, such as inverted marking spray paint (also known as “upside down paint”), may be used by land surveyors, utility location experts, or anyone that has a need to mark a location on the ground. Marking paint may be used along with paint marking wands and/or paint marking wheels, which provide a convenient method of dispensing the marking paint onto the ground.

In many marking applications, a specified marking paint color may be required for identifying a certain entity. For example, once located, an underground power line may be marked with one color, an underground telephone line may be marked with another color, an underground gas line may be marked with yet another color, and so on. Further, the attributes of marking paint may be important for providing durability and/or ease of removal characteristics. Consequently, the marking paint formulations may vary according to durability and/or ease of removal specifications for different surfaces and uses. For example, municipalities may require that marking paint on streets and sidewalks fade away after only a few days. Therefore, it may be beneficial to develop mechanisms for ensuring, for example, that the proper color and/or formulation of marking paint is being used and/or has been used.

Additionally, in the marking industry, the aggregate cost of the marking paint for marking multiple locations may be substantial. However, while substantial in the aggregate, individual dispensers of marking paint are relatively inexpensive. Accordingly, the consumption of marking paint is hard to track and/or control as the cost of individual dispensers is generally thought of as insignificant by the marking technicians who, therefore, tend to be wasteful. For example, marking paint dispensers are often discarded before being completely emptied. Consequently, over time a significant amount of useful marking paint may be wasted, and, in addition to environmental concerns, the cost of supplying and/or replenishing the marking paint is not optimized.

Accordingly, approaches are needed for easily determining the type of marking paint that is being used in, for example, an underground facility locate operation and for monitoring the consumption of marking paint in the marking industry.

### SUMMARY OF THE INVENTION

According to a first aspect of the invention, a marking apparatus is provided to mark the presence or absence of an underground facility in a dig area. The marking apparatus comprises a housing configured to enable dispensing of a marker onto the ground for marking the presence or absence of an underground facility in a dig area; a marking dispenser holder affixed to the housing to hold at least one marking dispenser; an actuator to cause dispensing of the marker from the marking dispenser onto the ground in the dig area, in a marking operation, to mark presence or absence of an underground facility; at least one reader device to read ID information from an ID mechanism affixed to the marking dispenser; and a processing device to generate marker information in response to the ID information received from the reader device, the marker information representing at least one characteristic of the marking substance.

According to a second aspect of the invention, a method is provided for performing a marking operation for marking the presence or absence of an underground facility in a dig area using a marking apparatus that holds at least one marking dispenser. The method comprises dispensing a marker from the marking dispenser onto the ground in the dig area, in a marking operation, to mark the presence or absence of an underground facility, in response to activation of the marking dispenser; reading ID information from an ID mechanism affixed to the marking dispenser; and generating marker information in response to the ID information read from the ID mechanism.

### BRIEF DESCRIPTION OF THE DRAWINGS

For the purpose of illustrating the present invention, the drawings show aspects of one or more embodiments of the present invention. However, it should be understood that the present invention is not limited to the precise arrangements and instrumentalities shown in the drawings, wherein:

FIG. 1 is a schematic representation of a marking device for use with a marking dispenser having a machine-readable ID mechanism;

FIG. 2 is a front view of a marking dispenser having an RFID tag;

FIG. 3 is a functional block diagram of the marking device of FIG. 1;

FIG. 4 is a front view of a marking dispenser having a barcode; and

FIG. 5 is a flow diagram of a method of using a marking device having a machine-readable ID mechanism.

### DETAILED DESCRIPTION

The invention relates to marking devices for dispensing markers on the ground and to marking methods. The marking devices and marking methods use a marking dispenser having a machine-readable ID mechanism affixed thereto. The ID mechanism of the marking dispenser has data storage capability. In one embodiment of the present invention, the marking dispenser may be provided with a radio-frequency identification (RFID) tag. In another embodiment of the present invention, the marking dispenser may be provided with a barcode. The type of information that may be encoded in the ID mechanism of the marking dispenser may include, but is not limited to, product-specific information, user-specific information, other predetermined information of interest, and any combination thereof. The ID information encoded in the ID mechanism may be collected and used for various purposes, such as, but not limited to, real-time product verification, tracking which user location received a batch of marking paint, tracking marking paint inventory, tracking marking paint problems, and tracking marking paint usage.

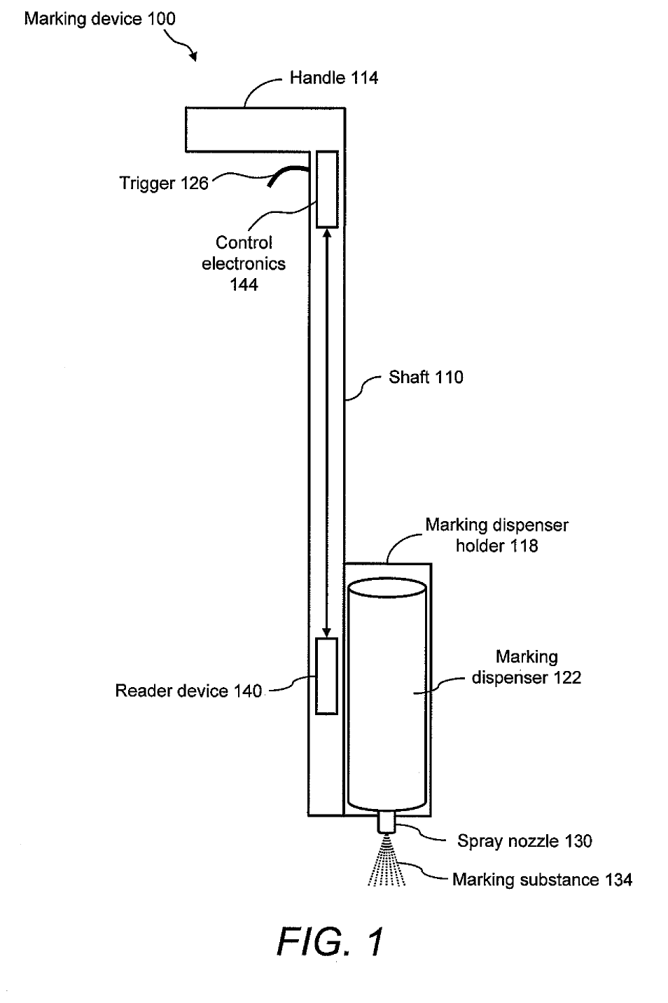

FIG. 1 is a schematic representation of a marking device 100, also referred to herein as a “marking apparatus”, that includes at least one reader device for reading an ID mechanism on a marking dispenser. Marking device 100 may include a shaft 110, handle 114 at one end of shaft 110 and a marking dispenser holder 118 for holding a marking dispenser 122 at the end of shaft 110 that is opposite handle 114. Additionally, marking device 100 may include a trigger 126 for actuating a spray nozzle 130 of marking dispenser 122 to dispense a marking substance 134 onto the target of a marking operation, such as the ground. Marking dispenser 122 may be an aerosol canister that contains a quantity of a marking substance 134. Marking substance 134 may be, for example, marking paint, marking chalk, marking dye, marking powder, and the like. In one example, marking dispenser may be an aerosol canister that contains marking paint, such as commercially available marking paint. Marking device 100 may be configured to hold a single marking dispenser or more than one marking dispenser.

A basic marking operation of marking device 100 may be described as follows. A user, such as a locate technician in an underground facility locate application, loads a marking dispenser 122 that contains a quantity of marking substance 134 into marking dispenser holder 118. The user grasps handle 114 of marking device 100 and aims nozzle 130 of marking dispenser 122 at the intended target. The user then pulls trigger 126, which may be mechanically and/or electrically coupled to spray nozzle 130 of marking dispenser 122 in order to dispense marking substance 134 in a specified pattern on the intended target, such as the ground. For example, marking device 100 may be used to mark lines, arrows, geometric shapes, numbers, letters, words, and combinations thereof on the ground.

Marking device 100 further includes at least one reader device 140 and control electronics 144, as described below. In some embodiments, marking device 100 is configured for mounting a single marking dispenser and includes at least one reader device. In other embodiments, marking device 100 is configured for mounting one or more marking dispensers and includes one or more reader devices for each marking dispenser. In further embodiments, marking device 100 includes two or more reader devices of the same or different types.

Marking dispenser 122 includes an ID mechanism 124 integrated therein or thereon. Marking dispenser 122 may be any canister for containing and dispensing a quantity of marking substance, such as marking paint or chalk. For example, marking dispenser 122 may be a standard aerosol canister that contains a quantity of the marking substance, such as, for example, commercially available marking paint.

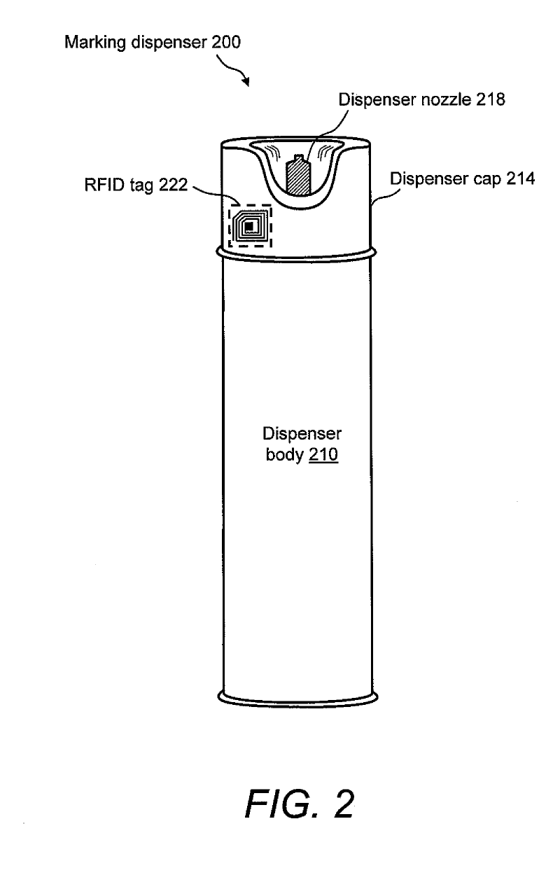

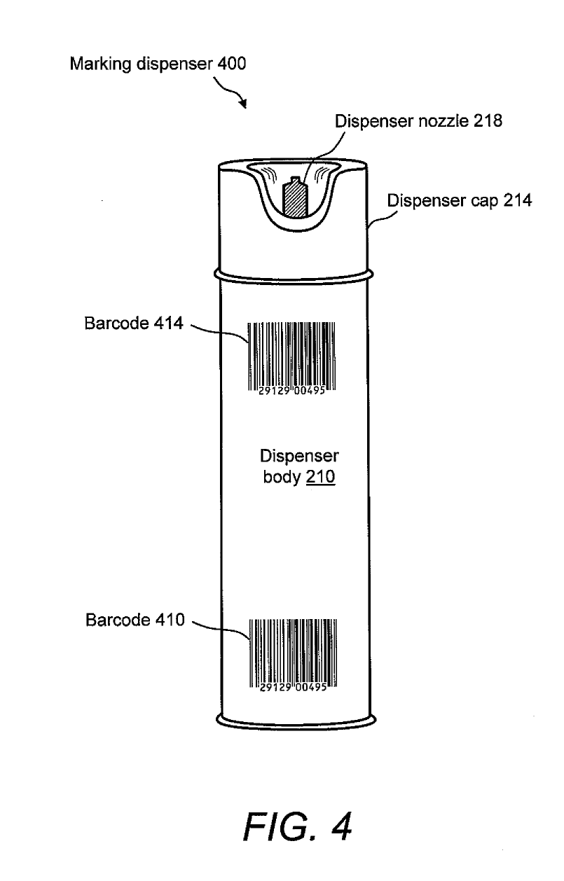

ID mechanism 124 may be, for example, a passive data storage mechanism that contains encoded information which is machine-readable via reader device 140. In one example, ID mechanism 124 may be an RFID tag device that stores information which may be read by an RFID reader. In another example, ID mechanism 124 may be one or more barcodes that store information which may be read by a barcode reader. The type of information that may be encoded in ID mechanism 124 may include, but is not limited to, product-specific information (e.g., manufacturer, brand, product code, lot or batch number, production date, paint color, paint formulation, and the like), user-specific information (e.g., office location of using company), other predetermined information of interest, and any combination thereof. More details of the marking dispenser 122 having ID mechanism 124 are described with reference to FIGS. 2 and 4.

FIG. 2 is a front view of a marking dispenser 200 having an RFID tag 222, which is one embodiment of marking dispenser 122. In this embodiment, marking dispenser 200 may include a dispenser body 210, which may be, for example, a metal aerosol canister for holding a quantity of marking paint, a dispenser cap 214, which may be a plastic cap that is mounted on dispenser body 210, and a dispenser nozzle 218 that is integrated into dispenser cap 214. Dispenser nozzle 218 is the mechanism through which the marking substance is dispensed from within dispenser body 210 via the action of, for example, aerosol propellant. The combination of dispenser body 210, dispenser cap 214, and dispenser nozzle 218 may be of the type commercially available for use as marking paint.

RFID tag 222 is integrated with dispenser cap 214 of marking dispenser 200. RFID tag 222 may be a RFID tag device, which may be a microchip (not shown) that is combined with an antenna (not shown) in a compact package that is structured to allow the RFID tag to be attached to an object. The antenna of the RFID tag receives signals from an RFID reader or scanner (not shown) and then transmits a signal containing the data of interest. In one example, RFID tag 222 may be a Generation 2 passive RFID tag that is weather resistant and dual-sided in order to reduce the read range.

Preferably, RFID tag 222 is attached to the inside of dispenser cap 214, in order to provide a tamper-resistant and weather-resistant package. Dispenser cap 214 may be formed of any material that is suitable for use with RFID technology. In one example, dispenser cap 214 may be formed of durable molded plastic.

The location of RFID tag 222 in marking dispenser 200 is not limited to the inside of dispenser cap 214. RFID tag 222 may be attached to any location on marking dispenser 200 where the transmit/receive functionality of RFID tag 222 is ensured. For example, RFID tag 222 may be attached to the outside of dispenser cap 214 or to the outside dispenser body 210.

In a typical paint marking device for marking on the ground, marking dispenser 200 may be installed upside down (i.e., dispenser cap 214-side down).

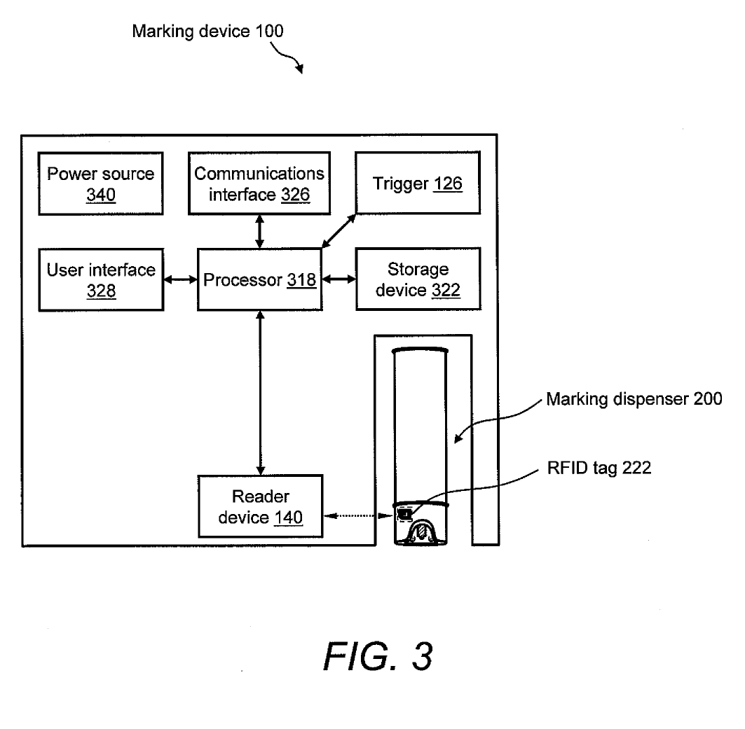

FIG. 3 is a functional block diagram of an embodiment of marking device 100 of FIG. 1. As shown, marking dispenser 200 having RFID tag 222 thereon is installed in marking device 100. Marking device 100 may include reader device 140, a processor 318, a storage device 322, a communications interface 326, a user interface 328, a trigger 330 and a power source 340.

In the embodiment of FIG. 3, reader device 140 is an RFID reader or scanner device. In this embodiment, the antenna of RFID tag 222 receives signals from reader device 140 and then transmits a signal that has the data of interest encoded therein. The position of RFID tag 222 relative to the location of reader device 140 is important. In one embodiment, reader device 140 may be a low frequency reader, such as a frequency of about 1356 megahertz (MHz), and has a read range from about 6 inches to about 8 inches.

Processor 318 may be any general-purpose processor, controller, or microcontroller device that is capable of controlling reader device 140 and managing the data that is received from RFID tag 222 via reader device 140. In one example, the data that is returned from reader device 140 may be stored locally in storage device 322. Storage device 322 may be any volatile or nonvolatile data storage device, such as, but not limited to, a random access memory (RAM) device and a removable memory device (e.g., a universal serial bus (“USB”) flash drive).

Communications interface 326 may be any wired and/or wireless interface by which data may be transmitted from marking device 100 to an external or remote device, such as a remote computing device. Example wired interfaces may include, but are not limited to, USB ports, RS232 connectors, RJ45 connectors, and any combination thereof. Example wireless interfaces may include, but are not limited to, Bluetooth® technology and IEEE 802.11 technology. Data stored in storage device 322 may be transmitted in real time or non-real time from marking device 100 via communications interface 326. Alternatively, data that is received from reader device 140 may be transmitted in real time via communications interface 326 with or without being stored locally in storage device 322.

User interface 328 may include any visual and/or audible device that can be used to provide information (depending on the type and function of ID mechanism 124) to the user of the marking device 100. For example, user interface 328 may include visual indicators, such as one or more light emitting diode (LED) devices and/or a display device, and one or more audible devices, such as a buzzer, a beeper, a speaker, and the like. The display device may include a display screen to display ID information read from ID mechanism 124 and/or marker information derived from the ID information. User interface 328 may also include one or more input devices, such as a touch screen or a keypad, to enable user input.

User interface 328 may include a set of visual indicators 328 which provide feedback to the user of the marking device 100. For example, visual indicators may provide immediate or substantially immediate feedback as to the color or any other characteristic of the marking paint in marking paint dispenser 200. For example, a light-emitting diode (LED) may be provided for each possible color of marking substance. The visual indicators may include red, orange, green, yellow, and blue LEDs. In one example, when marking dispenser 200 with RFID tag 222 is installed in marking device 100, reader device 140 scans RFID tag 222. Processor 318 processes the RFID data to determine the color of the marking substance in marking dispenser 200. Subsequently, processor 318 activates the LED that corresponds to the color of the marking substance that has been detected. In doing so, substantially immediate feedback is provided to the user of marking device 100. In this way, the user may verify, for example, that the intended color of marking substance has been installed. Alternatively, information based on the RFID data may be displayed on a display device.

Trigger 330 may be any mechanism by which a read operation of reader device 140 may be initiated. In one example, trigger 330 may be a program function that initiates a read of RFID tag 222 via reader device 140, such as a periodic read that is performed at set time intervals. In another example, trigger 330 may be an electronic trigger that occurs whenever the trigger 126 (FIG. 1) is pulled by the user to dispense the marking substance in marking dispenser 200. In this example, processor 318 passes this electronic trigger to reader device 140 anytime that the trigger of the wand is pulled.

The marking device 100 may be the marking device that is described in U.S. patent application Ser. No. 11/696,606, filed Apr. 4, 2007 and published Oct. 9, 2008 as Publication No. 2008/0245299, entitled “Marking system and method” and U.S. patent application Ser. No. 11/685,602, filed Mar. 13, 2007 and published Sep. 19, 2008 as Publication No. 2008/0228294, entitled “Marking system and method with location and/or time tracking,” both of which are incorporated by reference herein in their entirety.

FIG. 4 is a front view of a marking dispenser 400 having at least one barcode, which is another embodiment of the marking dispenser 122. In this embodiment, marking dispenser 400 is substantially the same as the marking dispenser 200 of FIG. 2, except that RFID tag 222 is replaced with one or more barcodes. For example, a first barcode, such as a barcode 410, maybe the manufacturer-specific barcode provided by the manufacturer of the marking substance. Optionally, a second barcode, such as a barcode 414, may be provided that has additional information encoded therein, such as the user-specific information (e.g., office location of using company). Referring to FIG. 3, in the case of using marking dispenser 400 within marking device 100, reader device 140 may be a barcode reader or scanner.

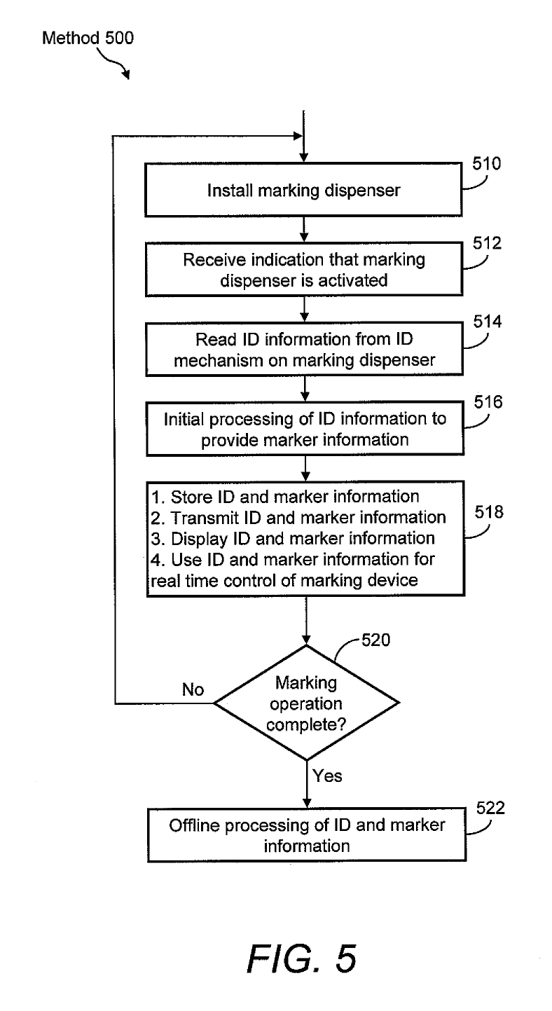

FIG. 5 is a flow diagram of a method 500 of operating marking device 100 using a marking dispenser having a machine-readable ID mechanism affixed thereto. The method 500 is described with reference to marking device 100 of FIGS. 1 and 3. Method 500 may include, but is not limited to, the following acts.

In act 510, marking dispenser 122 having machine-readable ID mechanism 124 is installed in the marking device 100. As described above, examples of the ID mechanism 124 include an RFID tag and a barcode.

In act 512, the trigger 126 of the marking device is pulled or otherwise activated by the user in order to dispense a quantity of marking substance 134 from the marking dispenser 122 onto the ground. The processor 318 receives an indication that the marking dispenser 122 has been activated to dispense marking substance 134.

In act 514, processor 318 causes reader device 140 to read ID information from the ID mechanism 124 on marking dispenser 122. For example, processor 318 may issue a command to reader device 140 to read ID information from ID mechanism 124 in response to the user activating the trigger 126 of the marking device 100 to dispense marking substance 134 onto the ground. For example, reader device 140 may scan RFID tag 222 (FIG. 2) or barcode 410 (FIG. 4). In other embodiments, the reader device 140 may be instructed to read the ID information from the ID mechanism 124 in response to one or more of a user query, power up of the marking device 100, a periodic signal, or installation of a marking dispenser in the marking device. The ID information read from ID mechanism 124 is supplied by reader device 140 to processor 318.

In act 516, processor 318 performs initial processing of the ID information read from the ID mechanism 124 to provide marker information. By way of example only, the ID information read from the ID mechanism may include a product code and a manufacturer code. The product code, the manufacturer code, or both, may be used to access corresponding product information stored in storage device 322. The stored product information may include marker information, such as for example, paint color, durability and intended application of the marking paint. In other embodiments, the ID information read from the ID mechanism 124 includes the desired marker information and does not require processing by processor 318. In this embodiment, the initial processing of act 516 may be optional. Thus, the ID information read from ID mechanism 124 may include information which requires initial processing by processor 318 to provide marker information and/or marker information read directly from ID mechanism 124.

In block 518, acts involving utilization of the ID information and/or the marker information are shown. The acts shown in block 518 may be performed separately or in any combination. The acts of block 518 may be performed or not performed, depending on the operating state of marking device 100 and on the application of marking device 100. Also, additional acts may involve the ID information and/or the marker information, or a selected subset thereof.

In act 518.1, the ID information and/or the marker information, or a selected subset thereof, is stored locally in storage device 322 of marking device 100. The ID information and/or the marker information can be stored separately or with other data in an electronic record of a marking operation or of operation of the marking device. The stored information, or a selected subset thereof, can be processed locally and/or transmitted to a remote device for processing, can be displayed on a display device and/or an indicator, and/or can be used for real-time control of the marking device, for example.

In act 518.2, the ID information and/or the marker information, or a selected subset thereof, is transmitted by communications interface 326 to a remote device. Examples of the remote device include i.e., a computer located in the vehicle of the user or a remote server, or both. Communications interface 326 may utilize wireless communication and/or a wired connection for transmission of the ID information and/or marker information. In one example of a wired connection, when the user returns to his/her home base, the marking device 100 may be connected by a wired connection to a central computing device. In particular, the marking device may be coupled to a docking station (not shown) that is designed to connect with communications interface 326. In doing so, the ID information and marker information that is stored locally within storage device 322 may be transmitted to the central computing device.

In act 518.3, the ID information and/or the marker information, or a selected subset thereof, may be displayed to the user, for example, on a display screen or via indicators. The ID and/or marker information may be for information only or may require an action by the user, such as verifying that the ID information and/or the marker information indicates that the marking dispenser is appropriate for the intended application. The display of ID information and/or marker information provides feedback to the user and permits verification that the intended marking dispenser 122 has been installed.

In act 518.4, the ID information and/or the marker information, or a selected subset thereof, is used for real-time control of the marking device 100. Thus, for example, selected ID information and/or marker information may be compared with reference information, for example, entered by the user. In the absence of a match, dispensing of the marking substance 134 from the marking dispenser 122 may be inhibited automatically. Other real-time control applications are included within the scope of the invention.

In act 520, a determination is made by processor 318 as to whether the marking operation is complete. For example, the user may indicate that it is necessary to install another marking dispenser of the same color in order to complete the marking operation or may indicate that another facility is to be marked at the same site, thus requiring installation of a marking dispenser of a different color. When the marking operation is not complete, the process returns to act 510.

When the marking operation is complete, as determined in act 520, the ID and/or marker information which has been stored in storage device 322 and/or transmitted to a remote device is ready for offline processing. By way of example only, offline processing may include compilation of data for a particular job site or determination of trends and statistics for multiple users. In addition, the ID and/or marker information may be processed for the purpose of tracking the inventory of marking paint dispensers., More specifically, the ID and/or marker information may be processed in order to analyze the usage of marking dispensers, such as the number of dispensers used and by what users. In another example, the ID and/or marker information may be processed for the purpose of quality control, such as to verify that the proper marking substances have been used in the assigned marking operations. The use of the ID and/or marker information is not limited to that mentioned above. The ID and/or marker information may be used for any purpose (e.g., real-time product verification, tracking what user location received what batch of marking paint, tracking marking paint inventory, tracking marking paint problems, tracking marking paint usage, and the like).

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A marking apparatus to mark the presence or absence of an underground facility in a dig area, comprising:
a housing configured to enable dispensing of a marker onto the ground for marking the presence or absence of an underground facility in a dig area;
a marking dispenser holder affixed to the housing to hold at least one marking dispenser;
an actuator to cause dispensing of the marker from the marking dispenser onto the ground in the dig area, in a marking operation, to mark presence or absence of an underground facility;
at least one reader device to read ID information from an ID mechanism affixed to the marking dispenser; and
a processing device to generate marker information in response to the ID information received from the reader device, the marker information representing at least one characteristic of the marker.

2. A marking apparatus as defined in claim 1, wherein the reader device comprises a radio frequency identification reader.

3. A marking apparatus as defined in claim 1, wherein the reader device comprises a barcode reader.

4. A marking apparatus as defined in claim 1, wherein the marking dispenser holder comprises a spray paint can holder.

5. A marking apparatus as defined in claim 1, wherein the reader device is configured to read at least a product code from the ID mechanism.

6. A marking apparatus as defined in claim 1, wherein the processing device is configured to automatically control at least one operation of the marking apparatus in response to the ID information.

7. A marking apparatus as defined in claim 1, further comprising a communication system, wherein the processing device is configured to transmit at least part of the marker information to a remote device using the communication system.

8. A marking apparatus as defined in claim 1, further comprising a local memory, wherein the processing device is configured to store at least part of the marker information in the local memory.

9. A marking apparatus as defined in claim 1, further comprising a user interface, wherein the processing device is configured to provide at least part of the marker information to the user interface.

10. A marking apparatus as defined in claim 1, further comprising a display device, wherein the processing device is configured to display at least part of the marker information on the display device.

11. A marking apparatus as defined in claim 1, further comprising one or more indicators, wherein the processing device is configured to activate at least one of the indicators in response to the marker information.

12. A marking apparatus as defined in claim 1, wherein the reader device is activated to read the ID information from the ID mechanism in response to dispensing of the marker from the marking dispenser.

13. A marking apparatus as defined in claim 1, wherein the reader device is activated to read the ID information from the ID mechanism in response to a user input.

14. A marking apparatus as defined in claim 1, wherein the reader device is activated to read the ID information from the ID mechanism in response to power up of the marking apparatus.

15. A marking apparatus as defined in claim 1, wherein the reader device is activated to read the ID information from the ID mechanism at periodic intervals.

16. A marking apparatus as defined in claim 1, wherein the reader device is activated to read the ID information from the ID mechanism in response to installation of a marking dispenser in the marking dispenser holder.

17. A marking apparatus as defined in claim 1, wherein the processing device is configured to compare information based on the ID information with reference information and to automatically inhibit dispensing of the marker in the absence of a match.

18. A marking apparatus as defined in claim 1, further comprising a communication system, wherein the processing device is configured to transmit at least part of the marker information to a remote device for inventory analysis.

19. A method for performing a marking operation for marking the presence or absence of an underground facility in a dig area using a marking apparatus that holds at least one marking dispenser, comprising:
dispensing a marker from the marking dispenser onto the ground in the dig area, in a marking operation, to mark the presence or absence of an underground facility, in response to activation of the marking dispenser;
reading ID information from an ID mechanism affixed to the marking dispenser; and
generating marker information in response to the ID information read from the ID mechanism.

20. A method as defined in claim 19, wherein reading ID information comprises reading a radio frequency identification tag.

21. A method as defined in claim 19, wherein reading ID information comprises reading a barcode.

22. A method as defined in claim 19, wherein dispensing a marker comprises dispensing paint from a spray paint can holder.

23. A method as defined in claim 19, wherein reading ID information comprises reading at least a product code from the ID mechanism.

24. A method as defined in claim 19, further comprising automatically controlling at least one operation of the marking apparatus in response to the ID information.

25. A method as defined in claim 19, further comprising transmitting at least part of the marker information to a remote device using a communication system.

26. A method as defined in claim 19, further comprising storing at least part of the marker information in a local memory.

27. A method as defined in claim 19, further comprising providing at least part of the marker information to a user interface.

28. A method as defined in claim 19, further comprising displaying at least part of the marker information on a display device.

29. A method as defined in claim 19, further comprising activating at least one indicator in response to the marker information.

30. A method as defined in claim 19, wherein the ID information is read from the ID mechanism in response to dispensing of the marker from the marking dispenser.

31. A method as defined in claim 19, wherein the ID information is read from the ID mechanism in response to a user input.

32. A method as defined in claim 19, wherein the ID information is read from the ID mechanism in response to power up of the marking apparatus.

33. A method as defined in claim 19, wherein the ID information is read from the ID mechanism at periodic intervals.

34. A method as defined in claim 19, wherein the ID information is read from the ID mechanism in response to installation of a marking dispenser in the marking dispenser holder.

35. A method as defined in claim 19, further comprising comparing information based on the ID information with reference information and automatically inhibiting dispensing of the marker in the absence of a match.

36. A method as defined in claim 19, further comprising transmitting at least part of the marker information to a remote device for inventory analysis.
